(19) United States
(12) Patent Application Publication
(10) Pub. No.: US 2007/0215065 A1
(43) Pub. Date: Sep. 20, 2007

(54) DEVICE FOR WALKING PETS

(76) Inventor: Kenneth Edward Furlich, Cleveland Heights, OH (US)

Correspondence Address: FAY SHARPE LLP, 1100 SUPERIOR AVENUE, SEVENTH FLOOR, CLEVELAND, OH, 44114, US

(21) Appl. No.: 11/686,139

(22) Filed: Mar. 14, 2007

Related U.S. Application Data
(60) Provisional application No. 60/782,815, filed on Mar. 17, 2006.

(51) Int. Cl. A01K 27/00

(52) U.S. Cl. 119/795

(57) ABSTRACT

An animal restraint device includes a rigid hub and a rigid handle rotatably connected to the hub. The hub includes at least one slot that each extends through the hub. Each slot is configured to receive a conventional leash for restraining an associated animal.

This application claims priority from U.S. Provisional Patent Application No. 60/782,815 filed on Mar. 17, 2006, which is hereby incorporated herein by reference in its entirety.

### BACKGROUND

A variety of devices have been created to aid one in walking multiple dogs. These known devices, however, have certain shortcomings, such as, a hand grip that is not ergonomical.

### BRIEF DESCRIPTION

In one example, an animal restraint device includes a rigid hub and a rigid handle rotatably connected to the hub. The hub includes a first slot and a second slot that each extend through the hub. Each slot is configured to receive a conventional leash for restraining an associated animal.

In another example, an animal restraint device includes a handle and a hub. The handle includes a grip portion that is configured to be gripped by an associated person's hand so that the person's fingers generally encircle a first axis. The hub includes a slot extending through the hub. The slot is configured to receive a conventional leash for restraining an associated animal. The hub is connected to the handle for rotation about a second axis that is at an angle other than perpendicular to the first axis.

In yet another example, a device for walking pets includes a rigid hub including two or more slots, a handle including a grip portion, and a fastening assembly connecting the rigid hub to the handle. Each slot is configured to accept an animal leash. The fastening assembly is configured to allow the rigid hub to rotate relative to the handle.

### BRIEF DESCRIPTION OF THE DRAWINGS

FIG. 1 is a side elevation of a multiple animal-walking device having leashes attached to the device.

FIG. 2 is a pictorial view of the multiple animal-walking device as utilized by an individual to walk two pets simultaneously.

FIG. 3A is a perspective view from above the device shown in FIG. 1.

FIG. 3B is a perspective view from below the device shown in FIG. 1.

FIG. 4 is a side elevation cross-sectional view of the device shown in FIG. 1.

FIG. 5A is a bottom perspective view of a rotating hub of the device shown in FIG. 1.

FIG. 5B is a top perspective view of the rotating hub as shown in FIG. 5A.

FIG. 6A is a side perspective view of a handle of the device shown in FIG. 1.

FIG. 6B is a bottom perspective view of the handle shown in FIG. 6A.

### DETAILED DESCRIPTION

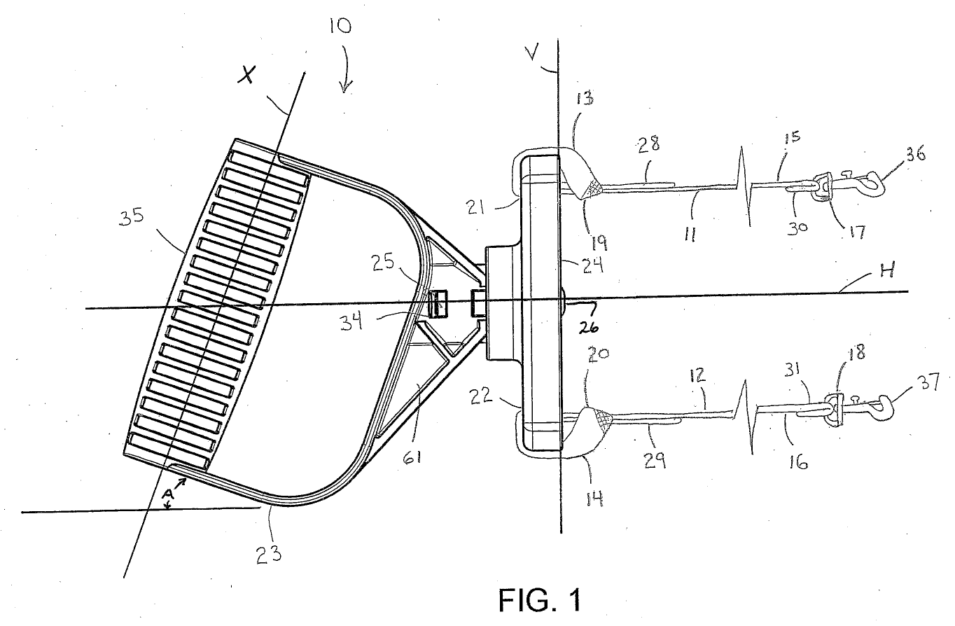

Referring to the drawings wherein like reference numerals designate identical parts throughout the several views, FIG. 1 shows an example of a restraint device 10 constructed in accordance with the present invention. Two separate leashes 11, 12 of the common sewn loop construction, but not limited to, are used. If desired, multiple leashes can attach to the device 10. The leash lines 11, 12 are generally made from a known nylon material. They include an upper end 13, 14 and a lower end 15, 16. The loops, which are typically used as handles, 19, 20 are constructed by sewing the material to itself with an area of stitching 28, 29 on the upper end. The lower ends are sewn together with an area of stitching 30, 31 to secure the swivel pad eye 17, 18 and the snap hook 36, 37 combination. The snap hooks 36, 37 are connected to the pet's collars 32, 33. In order to attach leashes 11, 12 to the device 10, one inserts the loops 19, 20 through slots 21, 22 (more than two slots or fewer than two slots can be provided) located in the rotating hub 24. One pulls the snap hook 36, 37 and swivel 17, 18 through the loop 19, 20 and pulls until the entire leash line 11, 12 is tightened up against the slot 21, 22 located on the rotating hub 24.

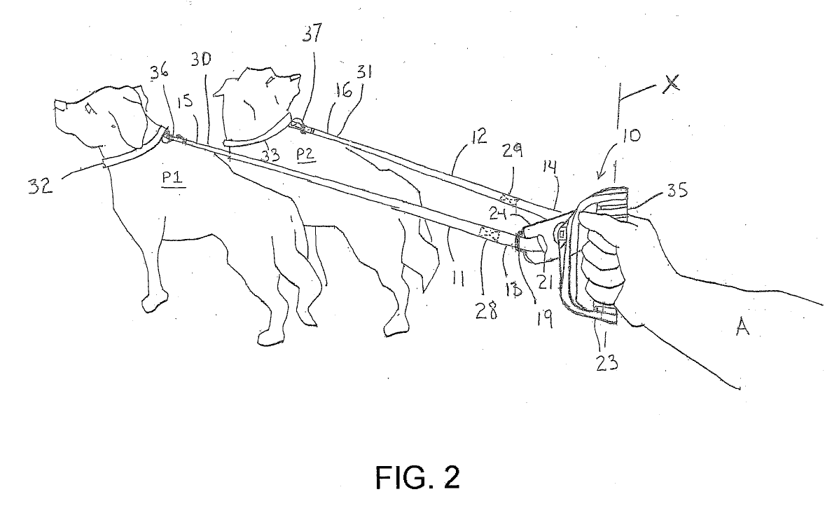

FIG. 2 shows the device 10 with two pets (dogs in the picture) P1, P2 secured to the rotating hub 24. The individual A holds the handle assembly 23 at the grip 35.

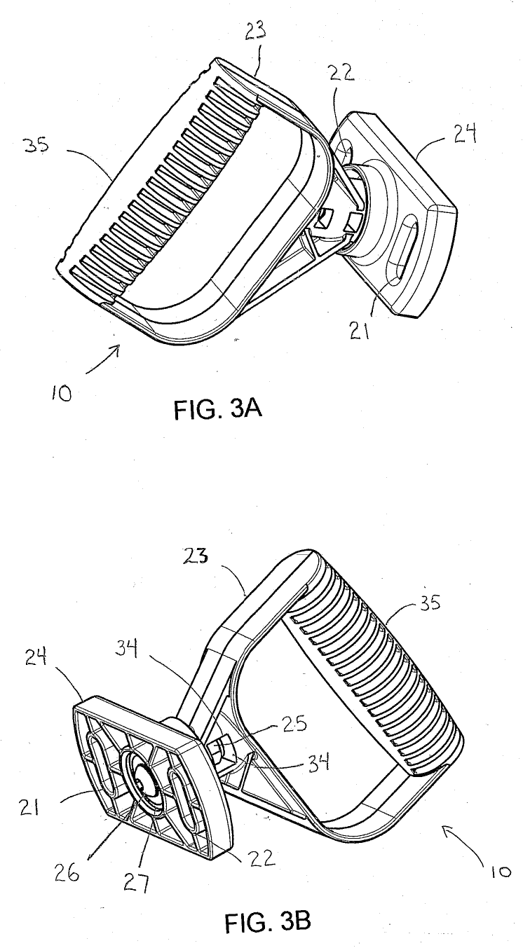

FIGS. 3A and 3B show the device 10 from two different viewpoints. The cavity 34 for the elastic stop nut 25 is better seen in FIG. 3B. Slots 21, 22 are also more visible without the leashes being installed in the device 10. The handle 23 is designed to be at an ergonomically friendly angle A (FIG. 1) of, but not limited to, about 10 degrees to about 30 degrees off the horizontal axis H, and preferably about 20 degrees off the horizontal axis H. This offset angle A is to provide proper alignment with the handler's arm and wrist.

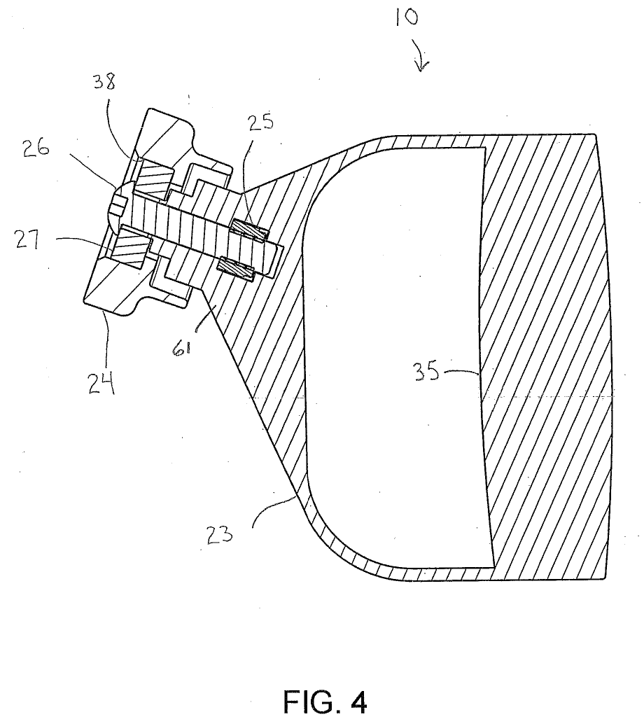

FIG. 4 is a cross-sectional side view of the device of the present invention 10. A fastening assembly connects the handle to the hub. The ball bearing 27 is pressed into the bearing cavity 38 in the hub. The elastic stop nut 25 is placed into the nut cavity 34 in the handle. The bolt 26 is sent through the center of the bearing 27 and rotating hub 24 and gets tightened to the elastic stop nut 25. Other fastening assemblies that would allow the handle 23 to rotate with respect to the hub 24 can be employed.

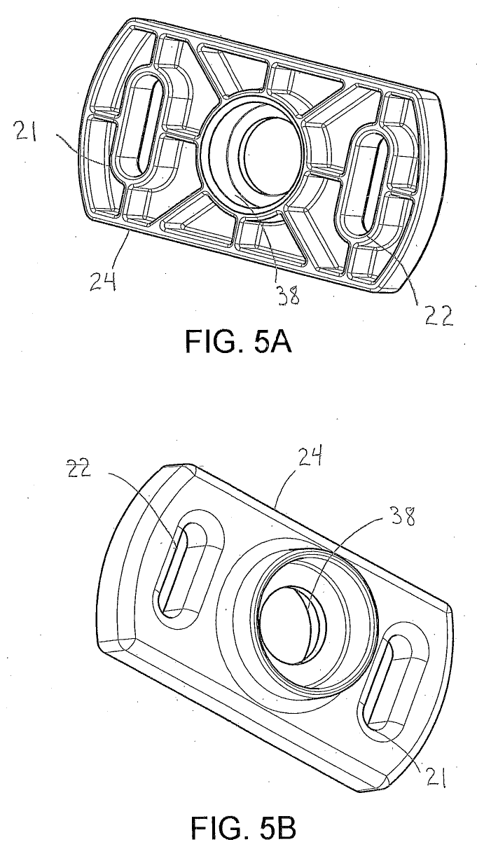

FIGS. 5A and 5B are more detailed views of the rotating hub 24. The rotating hub 24 is made of, but not limited to, a fiberglass reinforced resin for a lightweight and high strength combination.

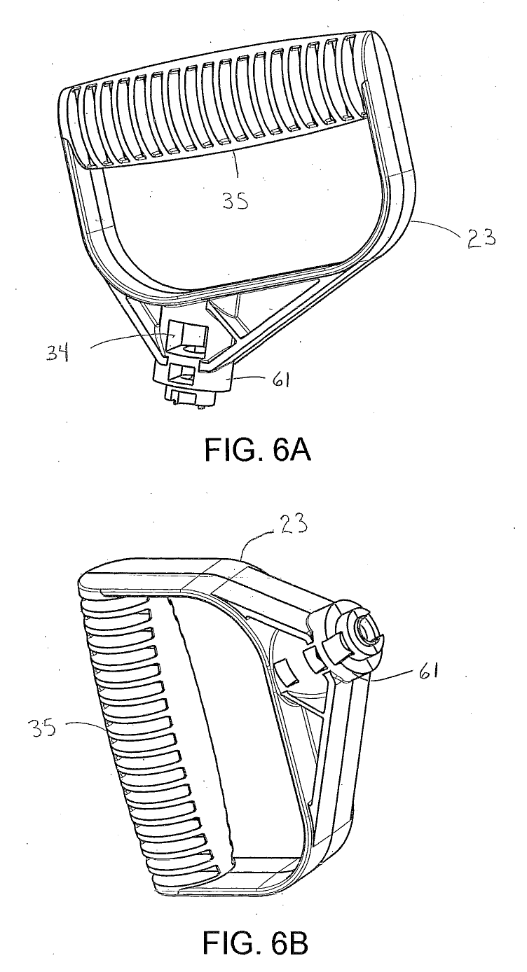

FIGS. 6A and 6B are more detailed views of the handle 23 as part of the present invention 10. The handle 23 is also made of, but not limited to, a fiberglass reinforced resin.

With reference back to FIG. 1, the rotating hub 24 can be referred to as generally residing in a plane, which is depicted in FIG. 1 as a vertical plane V. With reference to FIGS. 5A and 5B, the hub 24 is generally rectangular in plan view (having curved shorter sides), but it can take many other configurations. The slots 21 and 22 formed in the hub 24 are generally oblong having a major axis that is slightly larger than the height of a conventional pet leash. In the depicted embodiment, the slots 21 and 22 are disposed on opposite sides of the axis H (FIG. 1) about which the handle rotates with respect to the hub, or vice versa. This can aid in keeping the leashes from getting tangled; however, the slots can be located on the same side of the rotational axis or even be aligned with the rotational axis, if desired.

With reference back to FIG. 1, the handle 23 rotates with respect to the hub 24 in an axis H that is generally normal to the vertical plane V. The hand grip portion 35 of the handle 23 is a generally tubular elongated member as shown in FIG. 1. The hand grip portion 35 can take other configurations, for example, include depressions to receive the operator's fingers. The hand grip portion 35 is configured to be gripped by an associated person's hand so that the person's fingers generally encircle an axis X that is at an angle other than perpendicular with respect to the rotational axis H. In the depicted embodiment, the angle between the rotational axis H and the axis X is generally between about 60 degrees and about 80 degrees in a counterclockwise rotation, and preferably about 70 degrees. Accordingly, the axis X is also at an angle other than parallel to the plane V in which the rotating hub resides. The handle 23 includes a U-shaped member and the hand grip portion 35 interconnects opposite ends of the U-shaped portion. The handle 23 also includes an extension 61 that generally defines the nut cavity 34. As more clearly seen in FIGS. 1 and 4, the handle 23 connects to the hub 24 at the extension 61, which is offset from a symmetrical axis of the U-shaped portion (this axis being generally perpendicular to axis X).

The exemplary embodiment has been described with reference to the preferred embodiments. Moreover, directional terms such as “horizontal” and “vertical” have been used in describing the drawings. These terms are used to aid the reader in understanding the drawings and are not intended to limit the invention to any exact orientation. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An animal restraint device comprising:
a rigid hub including a first slot and a second slot each extending through the hub, each slot configured to receive a conventional leash for restraining an associated animal; and
a rigid handle rotatably connected to the hub.

2. The device of claim 1, wherein the hub rotates with respect to the handle in a first axis, the first axis being generally normal to a first plane, and the handle includes a hand grip aligned along a second axis, the second axis being disposed at an angle other than parallel to the first plane.

3. The device of claim 2, wherein the rigid hub generally resides in the first plane.

4. The device of claim 2, wherein the first axis is interposed between the first slot and the second slot.

5. The device of claim 1, wherein the handle includes a hand grip portion, the handle being connected to the hub such that when the hand grip is disposed generally vertically an axis about which the hub rotates with respect to the handle is disposed offset from horizontal.

6. The device of claim 1, wherein the handle includes a generally U-shaped portion and a hand grip interconnecting opposite ends of the U-shaped portion.

7. The device of claim 6, wherein the U-shaped portion of the handle is generally symmetrical with respect to a symmetrical axis and the handle pivots with respect to a rotational axis that is at an angle other than parallel to the symmetrical axis.

8. The device of claim 6, wherein the handle connects to the hub at a location that is offset from a symmetrical axis of the U-shaped portion.

9. The device of claim 1, wherein the handle includes a hand grip that generally resides in a first axis and the first axis is at an angle other that perpendicular to an axis in which the handle rotates with respect to the hub.

10. An animal restraint device comprising:
a handle including a grip portion that is configured to be gripped by an associated person's hand so that the person's fingers generally encircle a first axis; and
a hub including a slot extending through the hub, the slot being configured to receive a conventional leash for restraining an associated animal, the hub being connected to the handle for rotation about a second axis that is at an angle other than perpendicular to the first axis.

11. The device of claim 10, wherein the angle measured from the second axis to the first axis in a counterclockwise rotation is an acute angle.

12. The device of claim 11, wherein the angle is between about 60 degrees and about 80 degrees.

13. The device of claim 12, wherein the angle is about 70 degrees.

14. The device of claim 10, wherein the slot includes a first slot disposed on a first side of the side axis and a second slot disposed on a second side of the second axis.

15. A device for walking pets comprising:
a rigid hub including two or more slots, each slot configured to accept an animal leash;
a handle including a grip portion; and
a fastening assembly connecting the rigid hub to the handle, the fastening assembly being configured to allow the rigid hub to rotate relative to the handle.

16. The device of claim 15, wherein the rigid hub includes a passage that accepts the fastening assembly.

17. The device of claim 16, wherein the fastening assembly includes a cartridge bearing.

18. The device of claim 17, wherein the fastening assembly includes a bolt received through the cartridge bearing and a nut threaded onto the bolt.

19. The device of claim 15, wherein the grip portion is a generally tubular elongated member.

20. The device of claim 15, wherein the grip portion is angled with respect to an axis about which the rigid hub rotates relative to the handle at an angle other than perpendicular.
